(19) United States
(12) Patent Application Publication
(10) Pub. No.: US 2008/0095945 A1
(43) Pub. Date: Apr. 24, 2008

(54) Method for Making Macromolecular Laminate

(76) Inventors: Ching-Tang Wang, Taipei (TW); Wu-Tsang Tsai, Kaohsiung (TW); Lung-Chuan Wang, Kaohsiung Hsien (TW); Chung-Chih Feng, Kaohsiung (TW); Chun-Wei Wu, Kaohsiung Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/956,857

(22) Filed: Dec. 14, 2007

Related U.S. Application Data
(63) Continuation-in-part of application No. 11/026,869, filed on Dec. 30, 2004.

(51) Int. Cl. B05D 3/12

(52) U.S. Cl. 427/385.5

(57) ABSTRACT

A method for making a macromolecular laminate is disclosed. Firstly, a high solid-content polyurethane resin is prepared. The high solid-content polyurethane resin has a solid content higher than 80% by weight and a viscosity from 20000 to 60000 cps/30° C. The high solid-content polyurethane resin is liquid at the room temperature. The high solid-content polyurethane resin is mixed with additives to form a first type of polyurethane resin compound with a solid content higher than 50% by weight and a viscosity from 20000 to 60000 cps/30° C. The first type of polyurethane resin compound is liquid at room temperature and has a pot life of at least three hours at room temperature. The first type of polyurethane resin compound is coated on a releasing paper to make a main layer. Then, the releasing paper is removed from the main layer to make a laminate.

### CROSS REFERENCE TO RELATED APPLICATION

This is a continuation-in-part application of U.S. patent application Ser. No. 11/026,869 filed Dec. 30, 2004.

### BACKGROUND OF INVENTION

1. Field of Invention

The present invention relates to a method for making a macromolecular laminate.

2. Related Prior Art

In a conventional method for making a macromolecular laminate, granular, thin or powdery solid macromolecular compound (such as thermal plastic polyurethane (TPU), polypropylene, polyethylene and polyvinyl chloride) is mixed with additives, heated and molten. The mixture is injected, co-extruded or blow-molded to form a macromolecular laminate.

However, in the conventional method, because the solid macromolecular compound is used to make the macromolecular laminate, operative variables must be adjusted in order to solve problems related to melting, rheology and temperature. In a conventional method and equipment, there is a rather high minimum requirement on material. Furthermore, the complicated equipment must be cleaned up in order to make a different laminate. Therefore, it is material-intensive, time-consuming and expensive. In the conventional method for making the laminate, the hardness of the macromolecular resin such as TPU is about 85 to 98 (scale: Shore Hardness, A; test method: ASTM D-2240), and the 100% modulus is about 60 to 130 kg/cm² (test method: ASTM D-412). The laminate is hard, not soft. According to the conventional method and material, the laminate is made with only a few patterns and colors. In the conventional method for using the solid macromolecular compound to make the macromolecular laminate, lubricant or plasticizer is used generally. The lubricant or plasticizer is however released from the surface of the laminate so that the surface of the laminate loses its brightness.

### SUMMARY OF INVENTION

The primary objective of the present invention is to provide a method for making a macromolecular laminate that can obviate or at least alleviate the problems encountered in prior art through making a laminate that can exhibit a lot of patterns and colors and flexibility.

To achieve the above-mentioned objective and other objectives, the present invention provides a method for making a macromolecular laminate. Firstly, a high solid-content polyurethane resin is prepared. The high solid-content polyurethane resin has a solid content higher than 80% by weight and a viscosity from 20000 to 60000 cps/30° C. and is liquid at room temperature. The high solid-content polyurethane resin is mixed with additives to form a first type of polyurethane resin compound with a solid content higher than 50% by weight and a viscosity from 20000 to 60000 cps/30° C. The first type of polyurethane resin compound is liquid and has a pot life of at least three hours at room temperature. The first type of polyurethane resin compound is coated on a releasing paper to make a main layer. Then, the releasing paper is removed from the main layer, leaving a macromolecular laminate.

To make the macromolecular laminate with colors, before the first polyurethane resin compound is coated, a second type of polyurethane resin compound is coated on the releasing paper to form an auxiliary layer. Then, the first type of polyurethane resin compound is coated on the auxiliary layer. The second type of polyurethane resin compound is made of polyurethane resin with solid content lower than 50% by weight. Thus, the auxiliary layer is thinner than the main layer. The auxiliary layer is made with a different color than the main layer so that the laminate exhibits a bright color. In addition, the releasing paper may include a pattern in order to leave a pattern on the laminate.

The present invention is characterized in using high solid-content polyurethane resin compound that is liquid at the room temperature to form the thick macromolecular laminate. According to an embodiment of the present invention, the high solid-content polyurethane resin compound is made of polyurethane resin with a solid content higher than 98% by weight, and the molecular weight thereof is controlled at a low value (about 40000 to 300000) through the reaction of a blocking agent such as CH3OH with an isocyanate group at macromolecular chain end so that the high solid-content polyurethane resin compound has low viscosity (about 20000 to 60000 cps/30° C.) and is liquid at the room temperature. At the latter stage of the process, the first type of polyurethane resin compound formed by the mixing of the high solid-content polyurethane resin compound with additives is de-blocked at a high temperature (about 140 to 170° C.) and then reacts with a cross-linking agent to form a macromolecular structure. The first type of polyurethane resin compound is liquid, has a long pot life at room temperature, and has a low viscosity and a solid content higher than 50% by weight, providing the advantages of easy coating, low volatile organic compounds as well as super hydrolysis resistance and abrasion resistance. Because no solid macromolecular compound is used, there is no need to control complicated variables in order to solve problems related to the melting, rheology and temperature of such solid macromolecular compound. In addition, a blender and a coating device can be used instead of a conventional bulky and complicated machine. Hence, the laminate can be made at a small or large number based on the need. Furthermore, only the blender and the coating device have to be cleaned between two different batches of laminates. Hence, the material, time and cost are reduced significantly. The laminate is flexible since it is made of polyurethane resin in the present invention. In addition, no lubricant is used since the first type of polyurethane resin compound is liquid at room temperature, thus the brightness lasts for long.

Other advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1a is a cross-sectional view of a laminate at a step of a method according to the present invention, and shows an auxiliary layer formed on releasing paper.

FIG. 1b is a cross-sectional view of the laminate at another step of the method according to the present invention, and shows a main layer formed on the auxiliary layer.

FIG. 1c is a cross-sectional view of the laminate at another step of the method according to the present invention, and shows the releasing paper removed in order to form a macromolecular laminate.

### DETAILED DESCRIPTION OF EMBODIMENTS

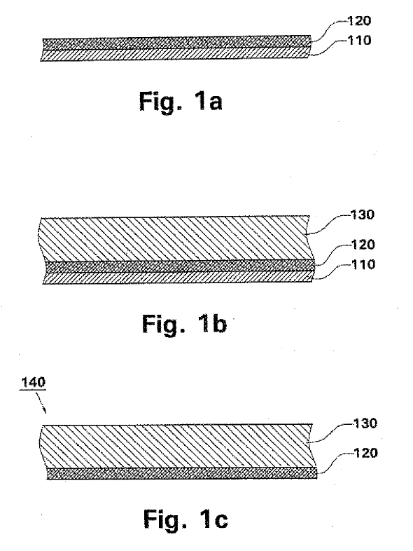

Referring to FIGS. 1a through 1c, a method for making a macromolecular laminate will be described. Firstly, referring to FIG. 1a, polyurethane resin is coated on releasing paper 110 and dried in order to form an auxiliary layer 120. Then, referring to FIG. 1b, a first type of polyurethane resin with a solid content higher than 50% by weight is coated on the auxiliary layer 120 and dried and cured in order to form a main layer 130. Finally, referring to FIG. 1c, the releasing paper 110 is removed in order to form a macromolecular laminate 140 with thickness of 0.01 to 3 mm.

A feature of the present invention resides in the preparation of a high solid-content polyurethane resin that has a solid content higher than 80% by weight and a viscosity from 20000 to 60000 cps/30° C. and that is liquid at room temperature. Then the high solid-content polyurethane resin is mixed with additives to form the first type of polyurethane resin compound having a solid content higher than 50% by weight and a viscosity from 20000 to 60000 cps/30° C. The first type of polyurethane resin compound is liquid at room temperature and has a pot life of at least three hours at room temperature. The first type of polyurethane resin is used to form the rather thick main layer 130 (the thickness of the main layer 130 may reach 3 mm) in order to provide the thick and elastic laminate 140.

The solid content of the polyurethane resin for making the main layer 130 is from 80% to 100% by weight and, more preferably, 99%. More specifically, the high solid-content polyurethane resin contains a relative small amount of organic dissolvent and does not release a large amount of organic dissolvent when forming the main layer 130. The thickness of the high solid-content polyurethane resin only changes a little before and after it is dried so that the polyurethane resin can easily form the thick main layer 130 that is thick and flexible.

Furthermore, one or more additives such as filler, auxiliary, crosslinker and colorant may be added to the high solid-content polyurethane resin. Preferably, the filler should be less than 50% of the high solid-content polyurethane resin. The filler should be less than 20% of the high solid-content polyurethane resin. The crosslinker should be less than 20% of the high solid-content polyurethane resin. The colorant should be less than 15% of the high solid-content polyurethane resin. In the embodiment of the present invention, preferably, the first type of polyurethane resin compound is baked at about 100 to 170 degrees Celsius. Moreover, foaming agent may be added to the high solid-content polyurethane resin in order to form a porous main layer 130.

Another feature of the present invention is using the low solid-content polyurethane resin to form the auxiliary layer 120 on the main layer 130. The solid content of the polyurethane resin for making the auxiliary layer 120 is lower than 50% by weight and, more preferably, 10% to 30%. For being made of the low solid-content polyurethane resin, the auxiliary layer 120 is thinner than the main layer 130. The auxiliary layer 120 may exhibit a different color than the main layer 130 so that the laminate 140 exhibits a desired color. Based on design requirements, the auxiliary layer 120 may be made to include a plurality of layers with a same color or different colors. Furthermore, the releasing paper 110 may include patterns in order to leave patterns on the laminate 140 after it is removed.

The present invention is characterized in that the first type of polyurethane resin compound which is liquid at room temperature with solid content higher than 50% by weight has low viscosity at room temperature and a long pot life (over 3 hours) at room temperature, providing advantages of easy coating, low volatile organic compounds as well as super hydrolysis resistance and abrasion resistance. Because no solid macromolecular compound is used, there is no need to control complicated variables in order to solve problems related to the melting, rheology and temperature of such solid macromolecular compound. In addition, a blender and a coating device can be used instead of a conventional bulky and complicated machine. Hence, the laminate 140 can be made at a small or large number based on the need. Furthermore, only the blender and the coating device have to be cleaned between two different batches of laminates 140. Hence, the material, time and cost are reduced significantly. The laminate 140 is flexible since it is made of polyurethane resin in the present invention.

In addition, because no lubricant is used, the brightness lasts for long. The macromolecular laminate of the present invention may be used as a logo or a surface layer adhered to ordinary leather.

The following embodiments are given in order to describe, not to limit, the present invention in detail:

### EXAMPLE 1

100 PHR of polyurethane resin, which is liquid at room temperature, with a solid content of 99% by weight and a viscosity of 20000 cps/30° C., 20 PHR of filler, 3 PHR of modifier, 5 PHR of crosslinker and 3 PHR of colorant were mixed to form a solid-content polyurethane resin coating with a solid content higher than 50% by weight. PHR (“parts per hundred parts of resin by mass”) means an amount of units of mass of additive added to 100 units of mass of the polyurethane resin.

After coated on patterned releasing paper, the polyurethane resin was dried at 165 degrees Celsius. Finally, the releasing paper was removed, thus leaving a thick, flexible and patterned laminate. The thickness of the laminate was 0.5 mm.

### EXAMPLE 2

100 PHR of polyurethane resin, which is liquid at room temperature, with a solid content of 99% by weight and a viscosity of 20000 cps/30° C., 20 PHR of filler, 3 PHR of modifier, 5 PHR of crosslinker and 3 PHR of were mixed to form a solid-content polyurethane resin coating with a solid content higher than 50% by weight. PHR (“parts per hundred parts of resin by mass”) means an amount of units of mass of additive added to 100 units of mass of the polyurethane resin.

Low solid-content polyurethane resin compound made of polyurethane resin with solid content lower than 20% was coated on releasing paper. The low solid-content polyurethane resin compound was dried at 120 degrees Celsius in order to form an auxiliary layer. The solid-content polyurethane resin with a solid content higher than 50% by weight was coated on releasing paper and dried at 165 degrees Celsius. Then, the releasing paper was removed, leaving a brightly colorful, thick and flexible laminate. The thickness of the laminate was 0.5 mm.

### COMPARATIVE EXAMPLE

Solid TPU resin was extruded to make a macromolecular laminate of a thickness of 0.5 mm.

The softness of the laminate of the comparative example was about 1.9, whereas the softness of the Example 1 and Example 2 was about 4.8. The softness test was conducted by a leather softness tester whose model number was BLC ST300 and manufactured by RWD BRAMLEY, a British company. The tested leather was softer as the value was higher. Hence, the laminate made according to the present invention is much softer than the conventional laminate.

The high solid-content polyurethane resin compound with low viscosity in accordance with the present invention was compared with the conventional solid macromolecular compound (such as thermal plastic polyurethane (TPU). The comparison is shown in Table 1 as follows:

TABLE 1

| | High solid-content | |
|---|---|---|
| | polyurethane resin | |
| | compound with low | Thermal plastic |
| Type of resin | viscosity | polyurethane (TPU) |
| Appearance | Liquid | Solid |
| Solid Content % | 50-100% | 100% |
| Viscosity | 20000-60000 cps | Solid |
| Property of | Excellent | Nay |
| Coating | | |
| Difficulty of | Easy | Difficult |
| processing | | |
| Method of | Can be prepared in | Injecting right |
| coating | advance | after reaction |
| Pot life | Can be stored for 4-8 | Nay |
| | hours | |
| Product | Macromolecular laminate | Macromolecular |
| | with high hydrolysis | laminate with poor |
| | resistance and abrasion | physical properties |
| | resistance | |

Table 1 shows that the method in accordance with the present invention has excellent properties in coating, processing and pot life compared to those of the conventional method, and the laminate made according to the method of the present invention has high hydrolysis resistance and abrasion resistance. Coating method of thermal plastic polyurethane must be dissolved into low solid content with dissolvent first. Storage of the thermal plastic polyurethane (TPU) must be stored in seal while storage of the high solid content polyurethane resin compound with low viscosity can be kept easily in ordinary drum.

The present invention has been described via detailed illustration of some embodiments. Those skilled in the art can derive variations from the embodiments without departing from the scope of the present invention. Therefore, the embodiments shall not limit the scope of the present invention defined in the claims.

What is claimed is:

1. A method for making a macromolecular laminate comprising:
preparing a high solid-content polyurethane resin with a solid content higher than 80% by weight and a viscosity from 20000 to 60000 cps/30° C., with the high solid-content polyurethane resin being liquid at room temperature;
mixing the high solid-content polyurethane resin with additives to form a first type of polyurethane resin compound with a solid content higher than 50% by weight and a viscosity from 20000 to 60000 cps/30° C., with the first type of polyurethane resin being liquid at room temperature and having a pot life of at least three hours at room temperature;
coating the first type of polyurethane resin compound on a releasing paper;
drying the first type of polyurethane resin compound to form a main layer; and
removing the releasing paper from the main layer to make the macromolecular laminate.

2. The method for making a macromolecular laminate according to claim 1, wherein the solid content of the high solid-content polyurethane resin is over 90% by weight.

3. The method for making a macromolecular laminate according to claim 1, wherein the additives comprise a filler less than 50% of the polyurethane resin.

4. The method for making a macromolecular laminate according to claim 1, wherein the additives comprise an auxiliary less than 20% of the polyurethane resin.

5. The method for making a macromolecular laminate according to claim 1, wherein the additives comprise a crosslinker less than 20% of the polyurethane resin.

6. The method for making a macromolecular laminate according to claim 1, wherein the additives comprise a colorant less than 15% of the polyurethane resin.

7. The method for making a macromolecular laminate according to claim 1, wherein drying is conducted at 110 to 170 degrees Celsius.

8. The method for making a macromolecular laminate according to claim 1, further comprising: coating a second type of polyurethane resin compound on the releasing paper, drying the second type of polyurethane resin compound to make an auxiliary layer, and coating the first type of polyurethane resin compound on the auxiliary layer.

9. The method for making a macromolecular laminate according to claim 8, wherein the second type of polyurethane resin compound is made of polyurethane resin with a solid content lower than 50% by weight.

10. The method for making a macromolecular laminate according to claim 1, wherein the molecular weight of the high solid-content polyurethane resin is about 40000 to 300000.
